(19) United States
(12) Patent Application Publication
(10) Pub. No.: US 2025/0269648 A1
(43) Pub. Date: Aug. 28, 2025

(54) LIQUID EJECTING APPARATUS AND SET OF LIQUIDS USED THEREIN

(71) Applicant: BROTHER KOGYO KABUSHIKI KAISHA, Nagoya (JP)

(72) Inventor: Yuki OKUMURA, Iwakura (JP)

(73) Assignee: BROTHER KOGYO KABUSHIKI KAISHA, Nagoya (JP)

(21) Appl. No.: 19/058,147

(22) Filed: Feb. 20, 2025

(30) Foreign Application Priority Data
Feb. 22, 2024 (JP) 2024-025383

(51) Int. Cl. B41J 2/165; C09D 11/38

(52) U.S. Cl. CPC B41J 2/16508; C09D 11/38

(57) ABSTRACT

A liquid ejecting apparatus may comprise: a head comprising a nozzle that ejects a first liquid including a solid component to a medium; a cap movable between a contact position and a separated position; a first tank storing a second liquid different from the first liquid and connected to the cap via a first flow path; a second tank connected to the cap via a second flow path different from the first flow path; and a controller. A density of the second liquid may be higher than a density of the first liquid. The controller may execute: a first supply process in which the second liquid is supplied into the cap via the first flow path from the first tank; and a first discharge process in which the second liquid is discharged from the cap to the second tank via the second flow path.

### REFERENCE TO RELATED APPLICATION

This application claims priority to Japanese Patent Application No. 2024-025383 filed on Feb. 22, 2024. The entire content of the priority application is incorporated herein by reference.

### BACKGROUND ART

A liquid ejecting apparatus is known. In this liquid ejecting apparatus, a head is covered by a cap containing a moisturizing liquid therein to maintain humidity around a nozzle of the head within a predetermined range. This prevents drying of the nozzle during storage.

### SUMMARY

In liquid ejecting apparatuses such as the one described above, the moisturizing liquid in the cap may contact a nozzle surface and ink in the nozzle may be diluted by the moisturizing liquid. The disclosure herein provides a technology that suppresses diluting of a liquid in a nozzle.

A liquid ejecting apparatus is disclosed herein. The liquid ejecting apparatus may comprise: a head comprising a nozzle configured to eject a first liquid including a solid component to a medium; a cap configured to be movable between a contact position where the cap contacts the head to cover the nozzle and a separated position where the cap is separated from the head; a first tank configured to store a second liquid different from the first liquid and connected to the cap via a first flow path; a second tank connected to the cap via a second flow path different from the first flow path; and a controller. A density of the second liquid may be higher than a density of the first liquid. The controller may be configured to execute: a first supply process in which the second liquid is supplied into the cap via the first flow path from the first tank; and a first discharge process in which the second liquid is discharged from the cap to the second tank via the second flow path.

According to the configuration above, the second liquid has a higher density than the first liquid, and thus the second liquid is subjected to a greater gravitational force than the first liquid. Therefore, even when the second liquid supplied into the cap contacts a nozzle surface, mixing of the first liquid in the nozzle with the second liquid can be suppressed. Diluting of the first liquid in the nozzle is thus suppressed.

Computer-readable instructions for implementing the above liquid ejecting apparatus and a non-transitory computer-readable recording medium storing the computer-readable instructions are also novel and useful. Methods carried out by the above liquid ejecting apparatus are also novel and useful. Further, a set of liquids including the first liquid and the second liquid used in the above liquid ejecting apparatus is also novel and useful.

### BRIEF DESCRIPTION OF DRAWINGS

FIG. 1 is a diagram showing an exterior configuration of an image recording apparatus 10.

FIG. 2 is a cross-sectional view taken along a line II-II in FIG. 1.

FIG. 3 is a bottom view of a head 32.

FIG. 4 is a diagram showing connection between an ink tank 48 and an ejection module 36.

FIG. 5 is a cross-sectional view of the ejection module 36 and a cap 60, where the cap 60 is in a contact position.

FIG. 6 is a cross-sectional view of the ejection module 36 and the cap 60, where the cap 60 is in a separated position.

FIG. 7 is a flowchart of a storage process.

FIG. 8 is a flowchart of a maintenance process.

### DESCRIPTION

### (Exterior Configuration of Image Recording Apparatus 10)

Referring to the drawings, an image recording apparatus 10 according to an embodiment is described. The image recording apparatus 10 is configured to eject ink to a sheet 2 according to an inkjet recording scheme to record images on the sheet 2. The image recording apparatus 10 is used on a desk. However, in another embodiment, the image recording apparatus 10 may be used on a floor or a rack.

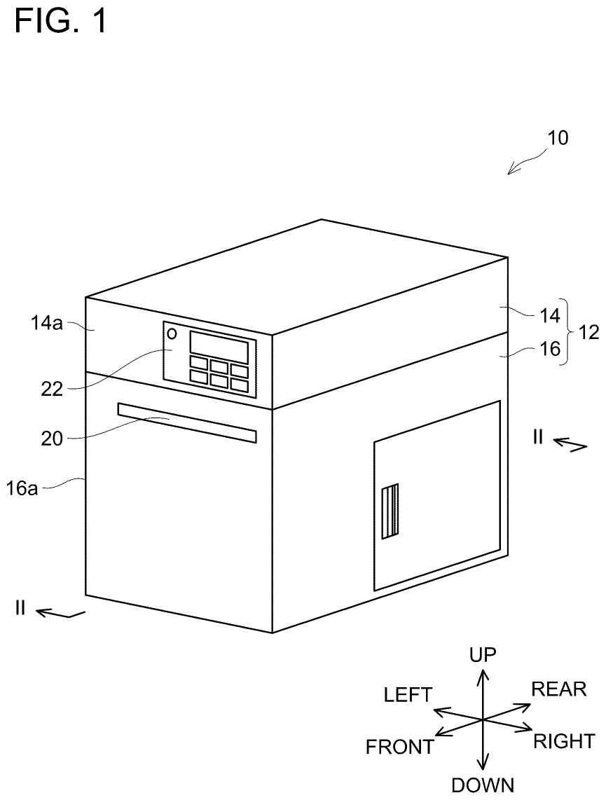

In the disclosure herein, directions are defined based on the installed state of the image recording apparatus 10. As shown in FIG. 1, an up-down direction is defined, where the direction toward an installation surface of the image recording apparatus 10 is a down direction; a front-rear direction is defined, where a direction toward an outlet 20 of the image recording apparatus 10 is a front direction; and a right-left direction is defined in the front view of the image recording apparatus 10.

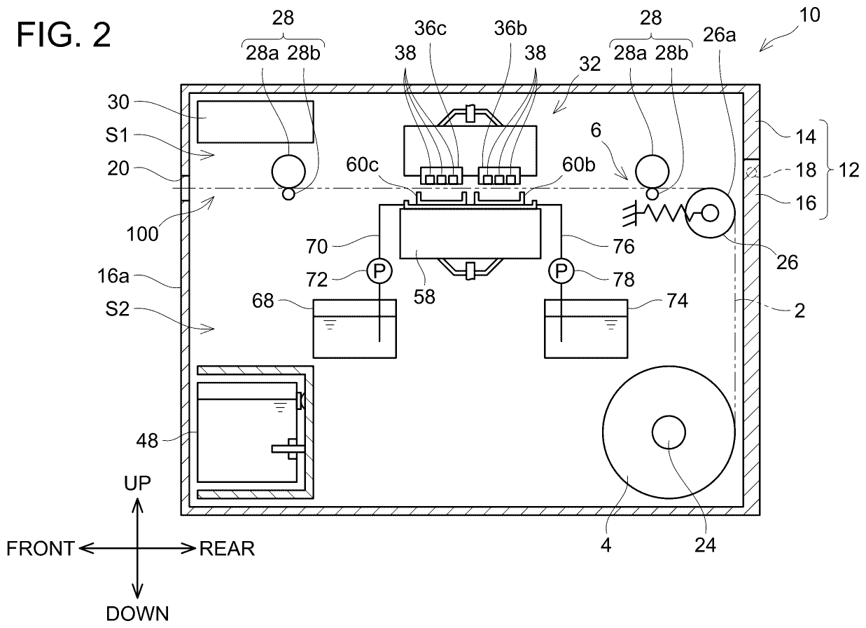

As shown in FIGS. 1 and 2, the image recording apparatus 10 comprises a housing 12. The housing 12 comprises an upper housing 14 and a lower housing 16. The upper housing 14 is supported by the lower housing 16 such that the upper housing 14 is rotatable about a rotation axis 18 extending in the right-left direction. Thus, the upper housing 14 is movable between a closed position (see FIGS. 1 and 2) and an open position (not shown). The upper housing 14 defines a first internal space S1 therein, and the lower housing 16 defines a second internal space S2 therein.

The image recording apparatus 10 further comprises an outlet 20. The outlet 20 is formed in a front surface 16a of the lower housing 16. The outlet 20 is a through hole that penetrates the lower housing 16 in the front-rear direction. The sheet 2 (see FIG. 2) on which images have been recorded comes out from the outlet 20.

As shown in FIG. 1, the image recording apparatus 10 further comprises an operation unit 22. The operation unit 22 is an interface through which a user can input various information to the image recording apparatus 10, and comprises, for example, a touch screen, buttons, etc. The operation unit 22 is located on a front surface 14a of the upper housing 14. The user can input, via the operation unit 22, an instruction to turn on the image recording apparatus 10, an instruction to turn off the image recording apparatus 10, an instruction to switch operation modes, etc.

### (Interior Configuration of Image Recording Apparatus 10)

As shown in FIG. 2, the image recording apparatus 10 further comprises a holder 24, a tensioner 26, two pairs of rollers 28, and a controller 30. The controller 30 is communicably connected to respective units of the image recording apparatus 10 and controls operations of these units. Although FIG. 2 shows components housed in the housing 12 for the purpose of illustration, the components are not necessarily located at positions as shown in FIG. 2.

The holder 24 supports a roll 4 on which the long sheet 2 is rolled. The holder 24 is located in a rear portion of the second internal space S2. The holder 24 is rotated by a feed motor (not shown). The roll 4 supported on the holder 24 rotates with the rotation of the holder 24.

The tensioner 26 is located above the holder 24. The tensioner 26 includes an outer surface 26a and the outer surface 26a contacts the sheet 2. The sheet 2 is first drawn out from the roll 4, curved along the outer surface 26a, and then sent out forward.

The two pairs of rollers 28 each comprise a feed roller 28a and a pinch roller 28b. Nips 6 are formed by the feed rollers 28a contacting the pinch rollers 28b. In the up-down direction, the nips 6 are located substantially at the same position as the upper end of the outer surface 26a of the tensioner 26. The two pairs of rollers 28 are rotated by a feed motor (not shown). The two pairs of rollers 28 are rotated while nipping the sheet 2 and thereby send the sheet 2 forward from the tensioner 26 toward the outlet 20. The number and positions of pairs of the rollers 28 are not particularly limited.

The sheet 2 follows a path 100 from the holder 24 to the outlet 20. Images are recorded on the sheet 2 while the sheet 2 is following this path 100.

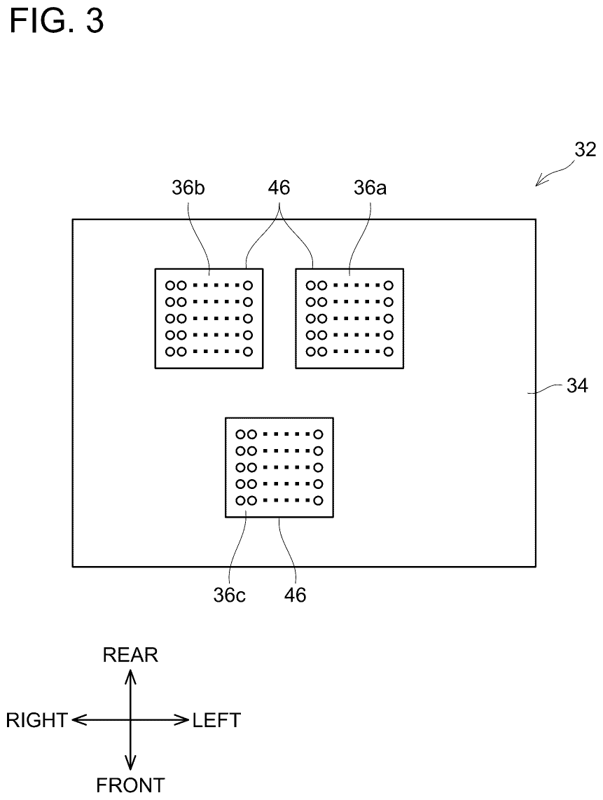

As shown in FIGS. 2 and 3, the image recording apparatus 10 further comprises a head 32. The head 32 is located above the path 100. The head 32 comprises a frame 34 and a plurality of ejection modules 36a, 36b, 36c. The frame 34 supports the plurality of ejection modules 36a, 36b, 36c.

The ejection module 36a is spaced from the ejection module 36b in the right-left direction. The ejection module 36c is spaced from the ejection modules 36a and 36b in the front-rear direction. Hereinafter, the ejection modules 36a, 36b, and 36c may be simply referred to “ejection modules 36”.

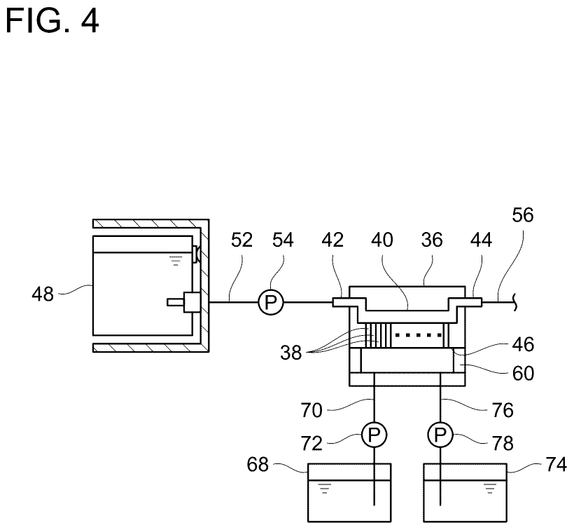

As shown in FIG. 4, the image recording apparatus 10 further comprises an ink tank 48, a first pump 54, and flow paths 52, 56. An ejection module 36 comprises a plurality of nozzles 38, a manifold 40, an inlet port 42, and an outlet port 44. Each nozzle 38 is open at a nozzle surface 46 of the ejection module 36. The nozzle surface 46 extends in the front-rear direction and the right-left direction. The nozzles 38 are connected to the manifold 40. One end of the manifold 40 is connected to the ink tank 48 storing ink therein via the inlet port 42 and the flow path 52. The other end of the manifold 40 is connected to the flow path 56 via the outlet port 44. When the first pump 54 located on the flow path 52 is driven by the controller 30, the ink is supplied from the ink tank 48 to the manifold 40 via the inlet port 42. Then, when piezoelectric elements (not shown) each corresponding to one of the nozzles 38 are driven, the ink in the manifold 40 is ejected through the nozzles 38 to the outside. Images are recorded on the sheet 2 by the nozzles 38 ejecting the ink toward the sheet 2 while the sheet 2 is following the path 100. A valve (not shown) is located on the flow path 56. When the valve is opened, the ink in the manifold 40 is discharged to the outside.

### (Ink)

The ink includes resin particles, a color material, an organic compound a surfactant, and a solvent (or a dispersion medium). The ink is an aqueous ink in which the resin particles, the color material, and the organic compound are dissolved in the solvent or dispersed in the dispersion medium.

The ink has wettability to hydrophobic recording media such as coated paper, plastics, films, OHP sheets, etc. However, this is not always the case, and the ink may be suitable for image recording on recording media other than hydrophobic recording media, such as plain paper, glossy paper, matte paper, etc. The coated paper is coated plain paper produced by applying a coating agent to plain paper mainly formed from pulp, such as high-grade printing paper, middle-grade printing paper, in order to improve smoothness, whiteness, glossiness, etc. Examples of the coated paper specifically include high-grade coated paper, middle-grade coated paper, etc. Generally, the coated paper has a lower water absorption rate than the plain paper. For example, resin particles including at least one of methacrylic acid and acrylic acid as monomer can be used as the resin particles. For example, commercially available resin particles may be used as the resin particles. The resin particles may further include, for example, styrene, vinyl chloride, etc. as monomer. The resin particles may be included in, for example, an emulsion. For example, the emulsion is constituted of the resin particles and a dispersion medium (e.g., water, etc.). The resin particles are not dissolved in the dispersion medium but are dispersed in the dispersion medium while having particle diameters within a predetermined range. Examples of the resin particles include, for example, acrylic acid resins, maleate ester resins, vinyl acetate resins, carbonate resins, polycarbonate resins, styrene resins, ethylene resins, polyethylene resins, propylene resins, polypropylene resins, urethane resins, polyurethane resins, polyester resins, copolymer resins thereof, etc.

For example, a resin having a glass-transition temperature (Tg) in a range of higher than or equal to 0° C. to equal to or lower than 200° C. may be used as the resin particles. The glass-transition temperature (Tg) may be, for example, in a range of higher than or equal to 20° C. to equal to or lower than 180° C. or in a rage of higher than or equal to 30° C. to equal to or lower than 150° C.

For example, commercially available emulsions may be used as the emulsion. Examples of the commercially available emulsions include, for example, “SUPERFLEX (registered trademark) 870” (Tg: 78° C.) and “SUPERFLEX (registered trademark) 150” (Tg: 40° C.) manufactured by DKS Co. Ltd.; “Mowinyl (registered trademark) DM774” (Tg: 33° C.) manufactured by Japan Coating Resin Corporation, “Hirose-X (registered trademark) KE-1062” (Tg: 112° C.), “Hirose-X (registered trademark) QE-1042” (Tg: 69° C.) manufactured by Seikou PMC Co., Ltd. and the like.

The average particle diameter of the resin particles is, for example, in a range of larger than or equal to 30 nm to equal to or smaller than 200 nm. The average particle diameter can be measured as an arithmetic mean diameter, for example, using a dynamic-light-scattering particle diameter distribution measuring device “LB-550” manufactured by HORIBA, Ltd.

A content (R) of the resin particles in the overall amount of the ink is, for example, in a range of more than or equal to 0.1 wt % to equal to or less than 30 wt %, in a range of more than or equal to 0.5 wt % to equal to or less than 20 wt %, or in a range of more than or equal to 1.0 wt % to equal to or less than 15 wt %. Only one kind of resin particles may be used, or two or more kinds of resin particles may be used together.

The color material is a pigment that can be dispersed in water, for example, by a pigment dispersing resin (resin dispersant). Examples of the color material include, for example, carbon black, inorganic pigments, organic pigments, etc. Examples of the carbon black include, for example, furnace black, lampblack, acetylene black, channel black, etc. Examples of the inorganic pigments include, for example, titanium oxide, iron oxide inorganic pigments, and carbon black inorganic pigments, etc. Examples of the organic pigments include, for example, azo pigments, polycyclic pigments, lake pigments, nitro pigments, nitroso pigments, aniline black daylight fluorescent pigments, etc. The azo pigments include, for example, azo lakes, insoluble azo pigments, condensed azo pigments, chelated azo pigments. The polycyclic pigments include phthalocyanine pigments, perylene and pelrinone pigments, anthraquinone pigments, quinacridone pigments, dioxazine pigments, thioindigo pigments, isoindolinone pigments, and quinophthalone pigments. The lake pigments include, for example, basic lake pigments, acidic lake pigments, etc.

A content of the color material solid component in the overall amount of the ink is not particularly limited and may be appropriately determined, for example, depending on the desired optical density, saturation, or the like. The content of the color material solid component is, for example, in a range of more than or equal to 0.1 wt % to equal to or less than 20.0 wt % or in a range of more than or equal to 1.0 wt % to equal to or less than 15.0 wt %. The content of the color material solid component is the weight of the pigment only and does not include the weight of the resin particles. Only one kind of color material may be used, or two or more kinds of color material may be used together.

A content of the solid components of the resin particles and the color material in the overall amount of the ink is, for example, in a range of more than or equal to 0.2 wt % to equal to or less than 20 wt %, in a range of more than or equal to 1 wt % to equal to or less than 15 wt %, in a range of more than or equal to 3 wt % to equal to or less than 14 wt %, or in a range of more than or equal to 6 wt % to equal to or less than 13 wt %.

The organic compound is not particularly limited, and any organic compounds can be used. Examples of the organic compound include, for example, propylene glycol; dipropylene glycol; tripropylene glycol; 1,3-propanediol; ethylene glycol; 1,2-butanediol; propylene glycol monobutyl ether; dipropylene glycol monopropyl ether; triethylene glycol monobutyl ether; 1,2-hexanediol; 1,6-hexanediol, and the like and glycol ether with propylene oxide group. Other examples of the organic compound include, for example, alkyl alcohol compounds with a carbon number of 1 to 4 such as methanol, ethyl alcohol, n-propyl alcohol, isopropyl alcohol, n-butyl alcohol, sec-butyl alcohol, tert-butyl alcohol, etc. Yet other examples of the organic compound include, for example, alkylene glycol compounds with alkylene groups including a carbon number of 2 to 6 such as ethylene glycol; propylene glycol; butylene glycol; triethylene glycol; 1,2,6-hexanetriol; thiodiglycol; hexylene glycol; diethylene glycol, etc. Still other examples of the organic compound include, for example, lower alkyl ether compounds of alkylene glycol compounds such as glycerin, ethylene glycol monomethyl (or ethyl, propyl, butyl) ether, diethylene glycol monomethyl (or ethyl, propyl, butyl) ether, triethylene glycol monomethyl (or ethyl, propyl, butyl) ether, tetraethylene glycol monomethyl (or ethyl, propyl, butyl) ether, propylene glycol monomethyl (or ethyl, propyl, butyl) ether, dipropylene glycol monomethyl (or ethyl, propyl, butyl) ether, propylene glycol monopropyl ether, dipropylene glycol monopropyl ether, tripropylene glycol monomethyl (or ethyl, propyl, butyl) ether, tetrapropylene glycol monomethyl (or ethyl) ether, etc. Yet other examples of the organic compound include N-methyl-2-pyrrolidone, 2-pyrrolidone, 1,3-dimethyl-2-Imidazolidinone, etc.

A content of the organic compound in the overall amount of the ink is, for example, 50 wt % or less, 40 wt % or less, 30 wt % or less, or 20 wt % or less when the organic compound is solely present in liquid form under 25° C.

Water may be ion-exchange water or pure water. A content of water in the overall amount of the ink is, for example, in a range of more than or equal to 15 wt % to equal to or less than 95 wt % or in a range of more than or equal to 25 wt % to equal to or less than 85 wt %. For example, the content of water may be a balance of the other components.

The ink may further include a generally known additive, as needed. Examples of the additive include, for example, surfactants, pH adjusters, viscosity modifiers, surface-tension modifiers, preservatives, fungicides, leveling agents, antifoam agents, light stabilizers, antioxidants, nozzle anti-drying agents, polymer components such as emulsions, pigments, etc. The surfactants may further include cationic surfactants, anionic surfactants, or nonionic surfactants. For example, these surfactants may be commercially available surfactants. Examples of these commercially available surfactants include, for example, “OLFINE (registered trademark) E1010”, “OLFINE (registered trademark) E1006”, “OLFINE (registered trademark) E1004”, “SILFACE SAG503A”, and “SILFACE SAG002” manufactured by Nissin Chemical Industry Co., Ltd., and the like. A content of surfactant in the overall amount of the ink is, for example, 5 wt % or less, 3 wt % or less, or in a range of more than or equal to 0.1 wt % to equal to or less than 2 wt %. Examples of the viscosity modifiers include, for example, polyvinyl alcohols, celluloses, water-soluble resins, etc.

The ink is prepared, for example, by homogeneously mixing the resin particles, the color material, the organic compound, water, and optionally an additive together using a generally known method, and removing undissolved residue by a filter or the like.

### (Configuration of Caps 60a, 60b, 60c)

As shown in FIG. 2, the image recording apparatus 10 further comprises a support 58 and a plurality of caps 60a, 60b, 60c. The support 58 supports the plurality of caps 60a, 60b, 60c. The caps 60a, 60b, and 60c can face the corresponding ejection modules 36a, 36b, and 36c, respectively, in the up-down direction. The cap 60a is not shown in the cross-sectional view of FIG. 2. Hereinafter, the caps 60a, 60b, and 60c may be simply referred to as “caps 60”. The number and arrangement of the ejection modules 36 are not particularly limited. Further, the number and arrangement of the caps 60 may be adapted to the number and arrangement of the ejection modules 36.

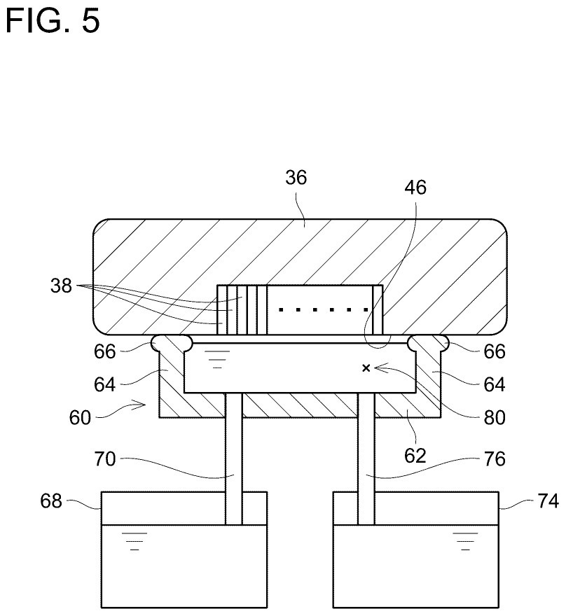

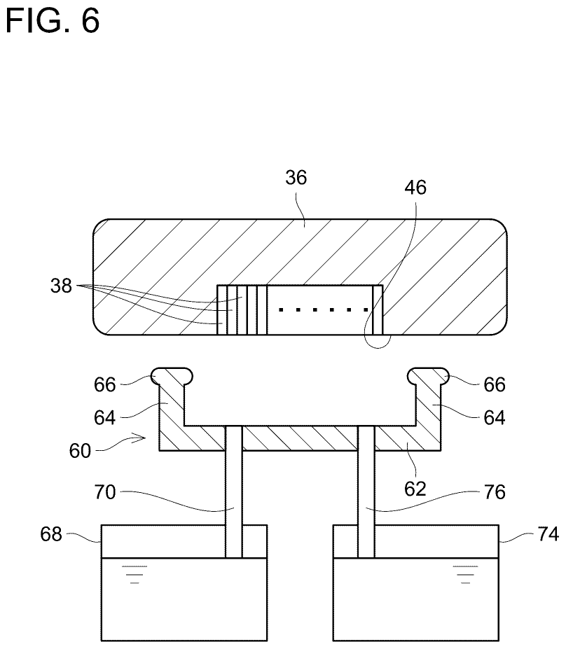

As shown in FIGS. 5 and 6, a cap 60 includes a bottom surface 62 and four side surfaces 64 extending upward from the periphery of the bottom surface 62. A lip 66 is located at the upper end of each side surface 64. The cap 60 is formed from an elastic material such as rubber, silicon, or the like. The cap 60 is configured to be movable between a contact position where the cap 60 contacts the head 32 (more specifically, the nozzle surface 46 of the ejection module 36 of the head 32) as shown in FIG. 5 and a separated position where the cap 60 is separated from the head 32 (the nozzle surface 46) as shown in FIG. 6. The support 58 is configured to be movable, for example, by being driven by a drive mechanism such as a motor controlled by the controller 30. The cap 60 moves together with the support 58 between the contact position and the separated position. When the cap 60 is in the contact position, the lips 66 of the cap 60 are in contact with the nozzle surface 46 (see FIG. 5). Thereby, the nozzles 38 are covered by the cap 60 and an internal space 80 is defined. When the cap 60 is in the separated position, the lips 66 of the cap 60 are separated from the nozzle surface 46 (see FIG. 6). Thus, the nozzles 38 are exposed.

### (Configurations for Supply and Discharge of Storage Liquid)

As shown in FIGS. 2 and 4 to 6, the image recording apparatus 10 further comprises a storage liquid tank 68, a flow path 70, and a second pump 72. The storage liquid tank 68 stores a storage liquid therein. The storage liquid is used to moisturize the nozzles 38 and clean the caps 60. The storage liquid tank 68 is connected to the caps 60 via the flow path 70. The second pump 72 is located on the flow path 70. When the second pump 72 is driven by the controller 30, the storage liquid is supplied from the storage liquid tank 68 into the caps 60 via the flow path 70.

The image recording apparatus 10 further comprises a waste liquid tank 74, a flow path 76, and a third pump 78. The waste liquid tank 74 is connected to the caps 60 via the flow path 76. The third pump 78 is located on the flow path 76. When the third pump 78 is driven by the controller 30, liquid in the caps 60 is discharged from the caps 60 to the waste liquid tank 74 via the flow path 76.

### (Storage Liquid)

The storage liquid includes water-soluble polymer, a water-soluble organic compound, a surfactant, and water. The density of the storage liquid is higher than the density of the ink. The density of the storage liquid may take any numerical value without any limitation as long as the density of the storage liquid is higher than the density of the ink.

The water-soluble polymer is dissolved in water which is a solvent. Any polymers may be used as the water-soluble polymer, without any limitation. Examples of the water-soluble polymer include, for example, polyvinylpyrrolidone, polyethylene glycol, etc. Other examples of the water-soluble polymer include polyvinyl alcohol compounds, polyvinylpyrrolidone compounds, polyacrylic acid compounds, styrene-acrylic acid copolymer compounds, acrylic acid-acrylic acid ester copolymer compounds, etc. Commercially available polymers may be used as the water-soluble polymer. Examples of such commercially available polymers include JONCRYL (registered trademark) manufactured by BASF, AQUALIC (registered trademark) manufactured by Nippon Shokubai Co., Ltd., ARON (registered trademark) manufactured by Toagosei Co., Ltd., etc. The water-soluble polymer may preferably contain an aromatic alkyl group or a lactam group in its structure. The weight-average molecular weight of the water-soluble polymer is, for example, in a range of more than or equal to 8,000 to equal to or less than 20,000 or in a range of more than or equal to 8,500 to equal to or less than 15,000.

Any water-soluble organic compounds may be used as the water-soluble organic compound without any limitation. Examples of the water-soluble organic compound include, for example, ethylene oxide; propylene glycol; ethylene glycol; 1,2-butanediol; propylene glycol propyl ether; dipropylene glycol monopropyl ether; diethylene glycol monobutyl ether; triethylene glycol monobutyl ether; 1,6-hexanediol, etc. The water-soluble organic compound may be preferably glycol ether with an ethylene oxide group. Other examples of the water-soluble organic compound include, for example, alkyl alcohol compounds with a carbon number of 1 to 4 such as methanol, ethyl alcohol, n-propyl alcohol, isopropyl alcohol, n-butyl alcohol, sec-butyl alcohol, tert-butyl alcohol, etc. Yet other examples of the water-soluble organic compound include, for example, alkylene glycol compounds with alkylene groups including a carbon number of 2 to 6 such as ethylene glycol; propylene glycol; butylene glycol; triethylene glycol; 1,2,6-hexanetriol; thiodiglycol; hexylene glycol; diethylene glycol, etc. Still other examples of the water-soluble organic compound include, for example, lower alkyl ether compounds of alkylene glycol compounds such as glycerin, ethylene glycol monomethyl (or ethyl, propyl, butyl) ether, diethylene glycol monomethyl (or ethyl, propyl, butyl) ether, triethylene glycol monomethyl (or ethyl, propyl, butyl) ether, tetraethylene glycol monomethyl (or ethyl, propyl, butyl) ether, propylene glycol monomethyl (or ethyl, propyl, butyl) ether, dipropylene glycol monomethyl (or ethyl, propyl, butyl) ether, tripropylene glycol monomethyl (or ethyl, propyl, butyl) ether, tetrapropylene glycol monomethyl (or ethyl) ether, etc. Yet other examples of the water-soluble organic compound include N-methyl-2-pyrrolidone, 2-pyrrolidone, 1,3-dimethyl-2-imidazolidinone, etc.

Only one kind of water-soluble organic compound may be used, or two or more kinds of water-soluble organic compounds may be used together. A content of the water-soluble organic compound in the overall amount of the storage liquid is, for example, in a range of more than or equal to 1 wt % to equal to or less than 50 wt % or in a range of more than or equal to 3 wt % to equal to or less than 35 wt %.

The surfactant is not particularly limited, and anionic surfactants, cationic surfactants, or nonionic surfactants may be used as the surfactant. For example, commercially available surfactants may be used as these surfactants. Examples of commercially available anionic surfactants include, for example, “SANNOL (registered trademark)” manufactured by Lion Corporation, “EMAL (registered trademark)” manufactured by Kao Corporation, “SANDET (registered trademark)” and “BEAULIGHT (registered trademark)” manufactured by Sanyo Chemical Industries, Ltd., etc. Only one kind of anionic surfactant may be used, or two or more kinds of anionic surfactants may be used together. A content of the anionic surfactant in the overall amount of the storage liquid is, for example, in a range of more than or equal to 0.01 wt % to equal to or less than 10 wt % or in a range of more than or equal to 0.1 wt % to equal to or less than 10 wt %.

The surfactant in the storage liquid may comprise one kind selected from anionic surfactants, cationic surfactants, and nonionic surfactants, or two or more kinds selected therefrom. In light of cleaning effect of the storage liquid for the caps 60, it is preferable that the surfactant included in the storage liquid may have the same polarity as that of the ink. For example, if charges of the solid components and additive included in the ink are anionic or nonionic, the surfactant included in the storage liquid may be anionic or nonionic. Especially, it is preferable that the surfactant included in the storage liquid is anionic.

Water may be ion-exchange water or pure water. A content of water in the overall amount of the storage liquid is, for example, in a range of more than or equal to 10 wt % to equal to or less than 90 wt % or in a range of more than or equal to 20 wt % to equal to or less than 80 wt %. For example, the content of water may be the balance of the other components.

The storage liquid may further include a generally known additive, as needed. Examples of the additive include, for example, moisturizers, pH adjusters, viscosity modifiers, surface-tension modifiers, fungicides, etc. Examples of the viscosity modifiers include, for example, polyvinyl alcohols, celluloses, water-soluble resins, etc.

The storage liquid can be prepared, for example, by homogeneously mixing the water-soluble polymer, the water-soluble organic compound, the surfactant, water, and optionally an additive together using a generally known method.

### (Operation Modes)

The image recording apparatus 10 is configured to operate selectively in any one of an image recording mode, a storage mode, and a maintenance mode. The image recording apparatus 10 may be configured to operate in another mode other than those modes. In the image recording mode, the ink in the ink tank 48 is ejected toward the sheet 2 to record images on the sheet 2. In the storage mode, the nozzles 38 are covered by the caps 60 to suppress drying of the nozzles 38. That is, in the storage mode, the ink is not ejected toward the sheet 2. In the maintenance mode, solidification of the ink in the nozzles 38 is suppressed and/or ink ejection problems are fixed. Hereinafter, a storage process executed by the controller 30 while the image recording apparatus 10 is operating in the storage mode and a maintenance process executed by the controller 30 while the image recording apparatus 10 is operating in the maintenance mode will be described.

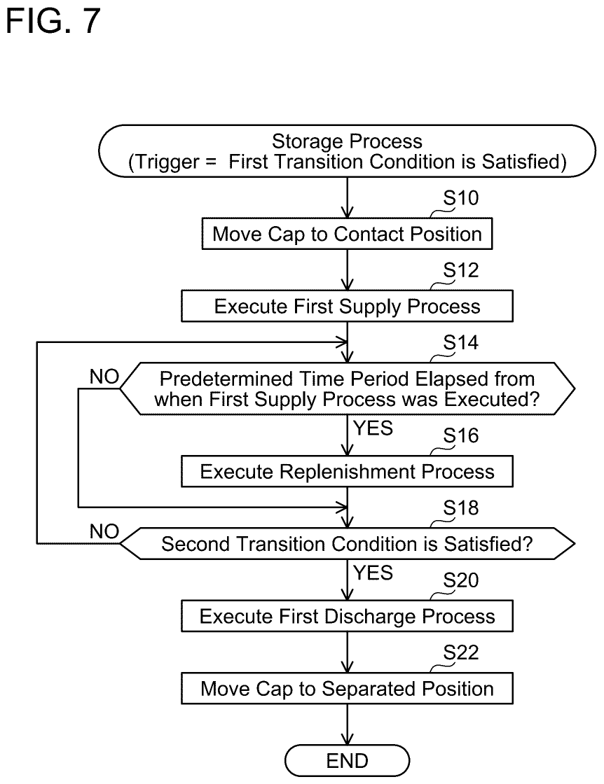

### (Storage Process: FIG. 7)

Referring to FIG. 7, the storage process is described. When a first transition condition is satisfied while the image recording apparatus 10 is operating in the image recording mode, the controller 30 causes the image recording apparatus 10 to transition to the storage mode and executes the storage process shown in FIG. 7. The first transition condition is satisfied in response to the ink having not been ejected from the nozzles 38 for more than a predetermined time period (e.g., a day). The first transition condition is also satisfied in response to an operation to turn off the image recording apparatus 10 being performed on the operation unit 22. In other words, the first transition condition is satisfied when the image recording apparatus 10 has not been used and/or is expected not to be used for a relatively long time period. According to this configuration, the storage process of FIG. 7 is automatically started in response to the first transition condition being satisfied. In another embodiment, the first transition condition may be satisfied only in response to the ink having not been ejected from the nozzles 38 for more than the predetermined time period or in response to the operation to turn off the image recording apparatus 10 being performed on the operation unit 22.

In S10, the controller 30 moves the caps 60 from the separated position (see FIG. 6) to the contact position (see FIG. 5). Thereby, the lips 66 of the caps 60 contact the nozzle surface 46 and the nozzles 38 are covered by the caps 60.

In S12, the controller 30 executes a first supply process. In the first supply process, the controller 30 drives the second pump 72 to supply the storage liquid from the storage liquid tank 68 into the caps 60 via the flow path 70. In the first supply process, as shown in FIG. 5, the storage liquid is supplied in an amount to fill, for example, about 90% of the capacity (i.e., the internal space 80) of the caps 60. Thus, after the storage liquid has been supplied, the surface of the storage liquid in each cap 60 is not in contact with the nozzle surface 46 and there is a space between the storage liquid surface and the nozzle surface 46. As described above, when the lips 66 of the caps 60 are in contact with the nozzle surface 46, the internal spaces 80 are defined in the caps 60 by the caps 60 and the nozzle surface 46. Since the storage liquid is supplied into the internal spaces 80, drying of the nozzles 38 can be suppressed without the storage liquid contacting the nozzle surface 46.

In S14, the controller 30 determines whether a predetermined time period has elapsed from when the first supply process was executed. For example, the predetermined time period is a week. When determining that the predetermined time period has elapsed (YES in S14), the controller 30 proceeds to S16, whereas when determining that the predetermined time period has not elapsed yet (NO in S14), the controller 30 proceeds to S18.

In S16, the controller 30 executes a replenishment process. In the replenishment process, the controller 30 drives the second pump 72 to replenish the caps 60 with the storage liquid by supplying it from the storage liquid tank 68 via the flow path 70. During the predetermined time period after the first supply process was executed, the storage liquid vaporizes and decreases in amount. By executing the replenishment process, the amounts of the storage liquid in the caps 60 are maintained within a predetermined range. Thus, drying of the nozzles 38 can be suppressed even after the predetermined time period has elapsed from when the first supply process was executed. For example, if the ink contains the solid components (the resin particles and the color material) in a relatively large amount, the ink is more likely to be solidified due to the vaporization of the solvent from the ink. The technology of the present embodiment is useful especially with the use of such inks. Further, since the replenishment process is executed at a specific timing after the first supply process was executed, the amounts of the storage liquid in the caps 60 can be maintained within a predetermined range without using an additional component such as a liquid level sensor.

In S18, the controller 30 determines whether a second transition condition for the image recording apparatus 10 to transition from the storage mode to the image recording mode is satisfied. The second transition condition is satisfied in response to an operation to transition the image recording apparatus 10 from the storage mode to the image recording mode being performed on the operation unit 22. The second transition condition is also satisfied in response to an operation to turn on the image recording apparatus 10 being performed on the operation unit 22. In another embodiment, the second transition condition may be satisfied only in response to the operation to transition the image recording apparatus 10 from the storage mode to the image recording mode being performed on the operation unit 22 or in response to the operation to turn on the image recording apparatus 10 being performed on the operation unit 22. When determining that the second transition condition is satisfied (YES in S18), the controller 30 proceeds to S20, whereas when determining that the second transition condition is not satisfied (NO in S18), the controller 30 returns to S14.

In S20, the controller 30 executes a first discharge process. In the first discharge process, the controller 30 drives the third pump 78 to discharge the storage liquid from the caps 60 to the waste liquid tank 74 via the flow path 76.

In S22, the controller 30 moves the caps 60 from the contact position to the separated position and then terminates the storage process. Thus, the image recording apparatus 10 transitions from the storage mode to the image recording mode.

In the storage process executed as described above, the caps 60 are filled to a certain level with the storage liquid, thereby suppressing the drying of the nozzles 38. For example, when the image recording apparatus 10 is transferred and/or when someone bumps into the image recording apparatus 10, the storage liquid surface in the caps 60 may ruffle and the storage liquid may contact the nozzle surface 46. If the density of the storage liquid is equal to or lower than the density of the ink, the ink in the nozzles 38 may mix with the storage liquid and may thereby be diluted. As a result, images may be recorded with the diluted ink when printing is executed thereafter. In order to prevent such events, in this embodiment, the density of the storage liquid is higher than the density of the ink. Thus, the storage liquid is subjected to a greater gravitational force than the ink. This suppresses the ink in the nozzles 38 from mixing with the storage liquid even when the storage liquid in the caps 60 contacts the nozzle surface 46. The diluting of the ink in the nozzles 38 can thus be suppressed.

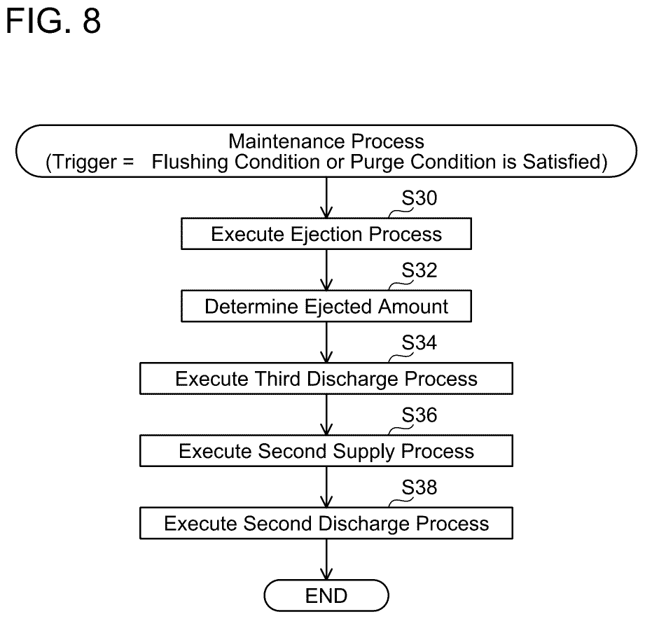

### (Maintenance Process: FIG. 8)

Now referring to FIG. 8, the maintenance process is described. In response to a flushing condition or a purge condition being satisfied, the controller 30 transitions the image recording apparatus 10 from the image recording mode or the storage mode to the maintenance mode and then executes the maintenance process shown in FIG. 8. The flushing condition is satisfied in response to an operation to execute a flushing process in the image recoding apparatus 10 being performed on the operation unit 22. The flushing condition is also satisfied in response to a predetermined time period having elapsed from when the last flushing process was executed while the image recording apparatus 10 is operating in the image recording mode. The flushing process is executed to suppress the solidification of the ink in the nozzles 38. The purge condition is satisfied in response to an operation to execute a purge process in the image recording apparatus 10 being performed on the operation unit 22. The purge condition is also satisfied in response to a sensor (not shown) detecting an ink ejection problem. The purge process is executed to fix such an ink ejection problem.

In S30, the controller 30 drives the third pump 78 and/or the piezoelectric elements (not shown) to execute an ejection process in which the ink is ejected from the nozzles 38. An amount of the ink to be ejected in the ejection process of the flushing process is less than an amount of the ink to be ejected in the ejection process of the purge process. Especially, in this embodiment, the controller 30, when executing the flushing process after having transitioned the image recording apparatus 10 from the image recording mode to the maintenance mode, executes the ejection process with the caps 60 maintained in the separated position. By contrast, the controller 30, when executing the purge process after having transitioned the image recording apparatus 10 from the image recording mode to the maintenance mode, moves the caps 60 from the separated position to the contact position and then executes the ejection process with the caps 60 being in contact with the nozzle surface 46.

In S32, the controller 30 determines the amount of ink ejected in the ejection process of S30. As described above, the amount of ink to be ejected in the flushing process is less than that in the purge process. Thus, the controller 30 determines that the amount of ink ejected is small when the ejection process of the flushing process was executed in S30, whereas the controller 30 determines that the amount of ink ejected is large when the ejection process of the purge process was executed in S30. The controller 30 may determine the amount of ink ejected in the ejection process by using a sensor that detects the actual amount of ink ejected.

In S34, the controller 30 executes a third discharge process. In the third discharge process, the controller 30 drives the third pump 78 to discharge the ink in the caps 60 to the waste liquid tank 74 via the flow path 76. Thereby, the ink ejected into the caps 60 can be discharged to the waste liquid tank 74 prior to cleaning of the caps 60, which will be described later. This allows for a reduction in the amount of the storage liquid to be used to clean the caps 60.

In S36, the controller 30 executes a second supply process. In the second supply process, the controller 30 drives the second pump 72 while the caps 60 are in the contact position to supply the storage liquid from the storage liquid tank 68 into the caps 60 via the flow path 70. Thereby, the ink adhering to the interiors of the caps 60 can be cleaned with the storage liquid. In S36, the controller 30 determines the amount of the storage liquid to be supplied in the second supply process based on the amount of ink ejected determined in S32. Specifically, when the controller 30 determined in S32 that the amount of ink ejected was small, i.e., when the ejection process of the flushing process was executed, the controller 30 supplies the storage liquid in a relatively small amount (e.g., an amount that fills about 30% of the capacity of the caps 60) in the second supply process. This configuration allows for efficient cleaning of the caps 60 with a small amount of the storage liquid. By contrast, when the controller 30 determined in S32 that the amount of ink ejected was large, i.e., when the ejection process of the purge process was executed, the controller 30 supplies the storage liquid in a relatively large amount (e.g., an amount that fills about 90% of the capacity of the caps 60) in the second supply process. This configuration allows for appropriate cleaning of the caps 60.

In S38, the controller 30 executes a second discharge process. In the second discharge process, the controller 30 drives the third pump 78 to discharge the liquid in the caps 60 (i.e., mixture of the ink and the storage liquid in the caps 60) to the waste liquid tank 74 via the flow path 76. In S38, as with S36, the caps 60 are in the contact position.

If the ink remains in the caps 60 or if the ink remains in the flow path 76 between the caps 60 and the waste liquid tank 74, the solid components in the ink may solidify as the solvent of the ink vaporizes. As described above, in this embodiment, the storage liquid supplied to the caps 60 includes the surfactant. The surfactant can soften the resulting solid by the action of hydrophobic group and also re-disperse the softened solid by the action of hydrophilic group. Thus, by executing the second discharge process (S38), the storage liquid as well as such re-dispersed sold in the ink can be discharged to the waste liquid tank 74. Possible resulting solids can thus be favorably removed.

In response to the first transition condition being satisfied while the image recording apparatus 10 is operating in the maintenance mode, the controller 30 may transition the image recording apparatus 10 to the storage mode and then execute the storage process of FIG. 7. The first transition condition in this case is satisfied, for example, in response to the operation to turn off the image recording apparatus 10 being performed on the operation unit 22. For example, after having executed the maintenance process of FIG. 8, the controller 30 transitions the image recording apparatus 10 from the maintenance mode to the storage mode and then executes the storage process of FIG. 7. Since the caps 60 are already in the contact position in S38 of FIG. 8, S10 of FIG. 7 is omitted. In this case as well, the first supply process (S12) is executed while the caps 60 are in the contact position. By the storage process being executed as above, the drying of the nozzles 38 can be suppressed and the diluting of the ink in the nozzles 38 can be suppressed.

In another embodiment, the caps 60 may be in the separated position in S38 of FIG. 8. In this case, after having executed the maintenance process of FIG. 8, the controller 30 may execute the storage process of FIG. 7 without omitting S10.

### (Correspondence Relationships)

The image recording apparatus 10 is an example of “liquid ejecting apparatus”. The ink is an example of “first liquid”. The resin particles and the color material are examples of “solid component”. The sheet 2 is an example of “medium”. The storage liquid is an example of “second liquid”. The flow path 70 is an example of “first flow path”. The storage liquid tank 68 is an example of “first tank”. The flow path 76 is an example of “second flow path”. The waste liquid tank 74 is an example of “second tank”. The image recording mode is an example of “first mode”. The storage mode is an example of “second mode”.

### Examples and Comparative Examples

Now, the ink and the storage liquid are described in more detail with reference to examples and comparative examples. However, the present invention is not limited to the examples.

### (Preparation of Ink and Storage Liquid)

By mixing the components listed in Table 1, three types of inks (ink 1 to ink 3) with different densities were prepared. Further, by mixing the components listed in Table 2, six types of storage liquids (storage liquid 1 to storage liquid 6) with different densities were prepared. The numerical values for the respective components in the tables indicate contents of the components relative to the overall amounts of the inks or storage liquids, and the unit of weight percentage is used.

TABLE 1

| Category | Material Name | Ink 1 | Ink 2 | Ink 3 |
|---|---|---|---|---|
| Resin Particles | Hirose-X QE-1042(40.5 weight %) | 11.4 | 11.4 | 11.4 |
| Color Material | Carbon Black | 5.0 | 5.0 | 5.0 |
| Organic | Glycerin | 10.0 | 25.0 | 40.0 |
| Compound | Triethylene Glycol Monobutyl Ether | 3.0 | 3.0 | 3.0 |
| Surfactant | Olfine E1004 | 0.3 | 0.3 | 0.3 |
| Solvent | Water | Balance | Balance | Balance |

| | | | |
|---|---|---|---|
| Total | 100.0 | 100.0 | 100.0 |
| Density[g/cm³] | 1.0590 | 1.0987 | 1.1398 |

TABLE 2

| | | Storage | Storage | Storage | Storage | Storage | Storage |
|---|---|---|---|---|---|---|---|
| Category | Material Name | Liquid 1 | Liquid 2 | Liquid 3 | Liquid 4 | Liquid 5 | Liquid 6 |
| Water-soluble | Polyvinylpyrrolidone | 0.2 | — | — | — | — | — |
| Polymer | (molecular weight 10000) | | | | | | |
| | Joncryl 62 | — | 0.6 | — | — | — | — |
| | (molecular weight 8500, | | | | | | |
| | 34 weight %) | | | | | | |
| Humectant | Glycerin | 30.0 | 30.0 | 30.0 | 30.0 | 40.0 | 10.0 |
| Organic | Triethylene Glycol | 3.0 | 3.0 | 3.0 | 3.0 | 3.0 | 3.0 |
| Compound | Monobutyl Ether | | | | | | |
| Surfactant | SANNOL NL-1430 | 3.0 | 3.0 | 3.0 | — | — | — |
| | (28 weight %) | | | | | | |
| | Olfine E1010 | — | — | — | 3.0 | — | — |
| Solvent | Water | Balance | Balance | Balance | Balance | Balance | Balance |

| | | | | | | |
|---|---|---|---|---|---|---|
| Total | 100.0 | 100.0 | 100.0 | 100.0 | 100.0 | 100.0 |
| Density[g/cm³] | 1.0740 | 1.7410 | 1.0730 | 1.0746 | 1.1005 | 1.0247 |

For the prepared inks and storage liquids, their degrees of mixing and redispersion performance of the storage liquids to solids were evaluated according to methods described below.

### (Mixing Test)

After an ink was introduced into the nozzles 38 of the image recording apparatus 10 and the caps 60 were moved to the contact position, a storage liquid was supplied into the caps 60. The storage liquid was supplied into the caps 60 in an amount enough for the supplied storage liquid to contact the nozzle surface 46. After five minutes from the supply, the caps 60 were moved to the separated position, and then the nozzle surface 46 was wiped with a sponge wiper (not shown). Thereafter, the ink was ejected from the nozzles 38 to coated paper to create an evaluation sample. Further, before the caps 60 were moved to the contact position (i.e., in the state where the ink in the nozzles 38 was not in contact with the storage liquid), the ink was ejected from the nozzles 38 to the coated paper to create a reference sample. Optical densities (ODs) of these samples were measured using a spectrophotometer (exact from X-Rite, Inc. (light source: D50, viewing angle: 2 degrees, ANSI-T)) to evaluate the degree of mixing for the ink and the storage liquid according to the measures below. Table 3 shows the evaluation results.
A: OD of the evaluation sample=OD of the reference sample
D: OD of the evaluation sample<OD of the reference sample

### (Redispersion Test)

An ink and a storage liquid were mixed together in a ratio of 1:9, and the mixture of 12 μL was dropped onto a flat plate formed from polypropylene. The flat plate was then kept for seven days under an environment with temperature of 60° C. and humidity of 30%. After pure water of 20 mL was dropped onto the aggregated mixture and manually oscillated, redispersion performance of the storage liquid to the solid was evaluated according to the measures below. Table 3 shows the evaluation results.
A: There is no solid in the liquid under the observation using a 200-power optical microscope (LV100ND from Nikon Corporation).
B: 50% or more of the solid is dispersed in the liquid under the visual observation.
C: Less than 50% of the solid is dispersed in the liquid under the visual observation.

TABLE 3

| | | | | | | | | Comparative | Comparative | Comparative |
|---|---|---|---|---|---|---|---|---|---|---|
| | | Example1 | Example2 | Example3 | Example4 | Example5 | Example6 | Example1 | Example2 | Example3 |
| Ink | | 1 | 1 | 1 | 1 | 1 | 2 | 1 | 2 | 3 |
| Storage Liquid | | 1 | 2 | 3 | 4 | 5 | 5 | 6 | 1 | 5 |
| Result | Mixing | A | A | A | A | A | A | D | D | D |
| | Redispersion | A | A | B | C | C | C | C | A | C |

### (Mixing Evaluation Results)

The OD of an evaluation sample being equal to the OD of the reference sample (evaluation result A) demonstrates that the ink was not diluted with the storage liquid, i.e., that the ink did not mix with the storage liquid. By contrast, the OD of an evaluation sample being less than the OD of the reference sample (evaluation result D) demonstrates that the ink was diluted with the storage liquid, i.e., that the ink mixed with the storage liquid. As shown in Table 3, examples 1 to 6 where the densities of the storage liquids are higher than the densities of the inks have confirmed that mixing of the inks with the storage liquids was favorably suppressed. By contrast, comparative examples 1 to 3 where the densities of the storage liquids are less than the densities of the inks revealed that the inks mixed with the storage liquids. As demonstrated, it has been revealed that even when a storage liquid supplied into the caps 60 contacts the nozzle 46, mixing of ink and the storage liquid can be suppressed as long as the density of the storage liquid is higher than the density of the ink. Further, as shown in the examples 1 to 6, it has been also revealed that the mixing can be favorably suppressed when the density of storage liquid is higher than the density of ink by at least 0.002 (g/cm3).

### (Redispersion Performance Evaluation Results)

As the solvent in the mixture of an ink and a storage liquid vaporizes, the solid components in the ink (“Hirose-X QE-1042” and carbon black) solidify and a solid is generated. As shown in Table 3, the examples 1 to 3 where the storage liquids contain a surfactant, especially an anion surfactant, show better results in solid redispersion performance than the embodiments and comparative examples where the storage liquids do not contain a surfactant. This would be because the generated solid was softened by the action of hydrophobic group of the surfactant and was re-dispersed by the action of hydrophilic group of the surfactant. Thus, by executing the second discharge process (S38), which is shown in FIG. 8, in the image recording apparatus 10, the re-dispersed solid in the ink can be discharged, along with the storage liquid, to the waste liquid tank 74 and thus appropriately removed. Generally, in perspective of solid removal, it is preferable that the ink is highly compatible with the storage liquid. The compatibility is improved, for example, when the ink and the storage liquid contain common component(s) or when they contain the common component(s) in similar amounts. Thus, by adjusting the compositions of ink and storage liquid while maintaining the density of the storage liquid higher than the density of the ink, both the suppression of mixing and the solid removal can be achieved. Here, “common component(s)” means not only components having exactly the same structure but also, for example, components having the same basic skeleton.

The example 4 where the storage liquid contains an nonionic surfactant (“OLFINE E1010”) shows a worse result in redispersion performance than the example 3 where the storage liquid contains an anionic surfactant (“SANNOL NL-1430”). This would be because the negative charge of the anionic surfactant affects the solid favorably and facilitates softening the solid, and further because when the surfactant included in the storage liquid is an anionic surfactant, the action of hydrophilic group of the surfactant is improved.

The examples 1 and 2 and the comparative example 2 where the storage liquids contain water-soluble polymers show better results in redispersion performance than the examples and comparative examples where the storage liquids do not contain any water-soluble polymers. This would be because the hydrophilic group of a surfactant effectively acts due to the storage liquid containing a water-soluble polymer. As a result, the solid can be favorably removed with the storage liquid even when the ink and the storage liquid are less likely to be mixed together due to their density difference.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

(Modification 1) In the embodiment described above, instead of the ink, a clear ink that does not include a color material may be ejected to the sheet 2 from the nozzles 38 of the head 32. The clear ink is used to impart gloss, protect printed images, and improve the quality of printed images. The clear ink is an aqueous ink containing resin particles as a solid component. In this modification, the clear ink and the resin particles are examples of “first liquid” and “solid component”, respectively.

(Modification 2) In the embodiment described above, instead of the ink, a pretreatment liquid that does not include a color material may be ejected to the sheet 2 from the nozzles 38 of the head 32. The pretreatment liquid is ejected to the sheet 2 before the ink is ejected for printing to improve the quality of images to be printed such as the color of the ink etc. The pretreatment liquid contains resin particles as a solid component. In this modification, the pretreatment liquid and the resin particles are examples of “first liquid” and “solid component”, respectively. In perspective of effect of cleaning the caps 60 with the storage liquid, for example, if the charges of the solid component and an additive are cationic, the storage liquid may preferably include a cationic surfactant or a nonionic surfactant.

(Modification 3) S10 and S12 in FIG. 7 may be transposed. That is, the controller 30 may move the caps 60 from the separated position to the contact position after executing the first supply process. In other words, the first supply process may be executed while the caps 60 are in the contact position or while the caps 60 are in the separated position. Generally, the first supply process may be executed after the caps 60 have been moved from the separated position to the contact position as in the embodiment described above, or the first supply process may be executed before the caps 60 are moved from the separated position to the contact position as in this modification.

(Modification 4) S20 and S22 in FIG. 7 may be transposed. That is, the controller 30 may execute the first discharge process after moving the caps 60 from the contact position to the separated position. Generally, the caps 60 may be moved from the contact position to the separated position after the first discharge process has been executed as in the embodiment described above, or the caps 60 may be moved from the contact position to the separated position before the first discharge process is executed as in this modification.

(Modification 5) The “first transition condition” is not limited to the one described in connection with the embodiment described above, and may include, for example, that a predetermined time arrives, that the user inputs an instruction for the storage process to be executed via the operation unit 22, or the like. Further, the “second transition condition” is not limited to the one described in connection with the embodiment described above, and may include, for example, that a predetermined time arrives.

(Modification 6) S14 and S16 in FIG. 7 may be omitted. In this modification, “replenishment process” may be omitted.

(Modification 7) The process of FIG. 8 may be omitted. In this modification, “ejection process”, “second supply process”, “second discharge process”, and “third discharge process” may be omitted. Alternatively, only S34 in the process of FIG. 8 may be omitted. In this modification, “third discharge process” may be omitted. In this case, in the second discharge process (S36), the mixture of the ink ejected into the caps 60 and the storage liquid supplied into the caps 60 is discharged to the waste liquid tank 74 via the flow path 76.

(Modification 8) S36 and S38 in FIG. 8 may be repeated. For example, in the case where it is determined in S32 that the amount of ink ejected was small, S36 and S38 may be executed M times (Mis an integer equal to or greater than 1), whereas in the case where it is determined in S32 that the amount of ink ejected was large, S36 and S38 may be executed N times (N is an integer greater than M). In this case, in the supply process of S36, the storage liquid may be supplied in the same amount (e.g., an amount that fills about 30% of the capacity of the caps 60) regardless of the determination result in S32. This configuration allows the caps 60 to be cleaned appropriately according to the amount of ink ejected in S30, without changing the supply amount of the storage liquid each time.

(Modification 9) S32 in FIG. 8 may be omitted. That is, in the supply process of S36, the storage liquid may be supplied in the same amount regardless of the amount of ink ejected in the ejection process of S30. Generally, “controller” may not determine the amount of the second liquid to be supplied in the second supply process based on the amount of the first liquid ejected in the ejection process.

(Modification 10) The ink is not limited to the one described in connection with embodiment described above. For example, the ink may not include the resin particles. Further, the storage liquid is not limited to the one described in connection with the embodiment described above. For example, the storage liquid may not include the surfactant or may not include the water-soluble polymer.

What is claimed is:

1. A liquid ejecting apparatus, comprising:
a head comprising a nozzle configured to eject a first liquid including a solid component to a medium;
a cap configured to be movable between a contact position where the cap contacts the head to cover the nozzle and a separated position where the cap is separated from the head;
a first tank configured to store a second liquid different from the first liquid and connected to the cap via a first flow path;
a second tank connected to the cap via a second flow path different from the first flow path; and
a controller,
wherein a density of the second liquid is higher than a density of the first liquid, and
wherein the controller is configured to execute:
a first supply process in which the second liquid is supplied into the cap via the first flow path from the first tank; and
a first discharge process in which the second liquid is discharged from the cap to the second tank via the second flow path.

2. The liquid ejecting apparatus according to claim 1, wherein the liquid ejecting apparatus is configured to operate in one of multiple modes including a first mode in which the first liquid is ejected to the medium and a second mode in which the first liquid is not ejected to the medium, and
wherein the controller is configured to:
in a case where a first transition condition for the liquid ejecting apparatus to transition to the second mode is satisfied, execute the first supply process in a state where the cap is at the contact position; and
in a case where a second transition condition for the liquid ejecting apparatus to transition from the second mode to the first mode is satisfied, execute the first discharge process and move the cap from the contact position to the separated position.

3. The liquid ejecting apparatus according to claim 2, wherein the first transition condition is satisfied in a case where the first liquid has not been ejected from the head for more than a predetermined time period and/or in a case where an operation to turn off the liquid ejecting apparatus is performed.

4. The liquid ejecting apparatus according to claim 2, wherein the second transition condition is satisfied in a case where an operation to transition the liquid ejecting apparatus to the first mode is performed and/or in a case where an operation to turn on the liquid ejecting apparatus is performed.

5. The liquid ejecting apparatus according to claim 1, wherein the controller is further configured to execute a replenishment process in which the second liquid is replenished into the cap via the first flow path from the first tank at a predetermined timing after the first supply process has been executed.

6. The liquid ejecting apparatus according to claim 5, wherein the predetermined timing is a timing after a predetermined time period from when the first supply process was executed.

7. The liquid ejecting apparatus according to claim 1, wherein the controller is further configured to execute:
an ejection process in which the first liquid is ejected from the nozzle into the cap,
a second supply process in which the second liquid is supplied from the first tank into the cap via the first flow path in a state where the cap is at the contact position after the ejection process has been executed; and
a second discharge process in which a liquid in the cap is discharged to the second tank via the second flow path after the second supply process has been executed.

8. The liquid ejecting apparatus according to claim 7, wherein the controller is further configured to execute a third discharge process in which the first liquid is discharged from the cap to the second tank via the second flow path after the ejection process has been executed and before the second supply process is executed.

9. The liquid ejecting apparatus according to claim 7, wherein the controller is configured to determine an amount of the second liquid to be supplied in the second supply process based on an amount of the first liquid ejected in the ejection process.

10. The liquid ejecting apparatus according to claim 1, wherein the second liquid comprises a surfactant and water.

11. The liquid ejecting apparatus according to claim 10, wherein the surfactant comprises an anionic surfactant.

12. The liquid ejecting apparatus according to claim 11, wherein the second liquid further comprises a water-soluble polymer.

13. The liquid ejecting apparatus according to claim 1, wherein the solid component comprises resin particles.

14. A set of liquids for use in the liquid ejecting apparatus according to claim 1, comprising:
the first liquid including the solid component, and
the second liquid having a higher density than a density of the first liquid.

15. The set of liquids according to claim 14, wherein the second liquid comprises a surfactant and water.

16. The set of liquids according to claim 15, wherein the surfactant comprises an anionic surfactant.

17. The set of liquids according to claim 16, wherein the second liquid further comprises a water-soluble polymer.
